(19) United States
(12) Patent Application Publication
(10) Pub. No.: US 2015/0363840 A1
(43) Pub. Date: Dec. 17, 2015

(54) Systems and Methods for Recommending Merchants to Consumers

(71) Applicant: MasterCard International Incorporated, Purchase, NY (US)

(72) Inventors: Amit Gupta, New Delhi (IN); Suneel Bhatt, New Delhi (IN); Prakash Bhatt, New Delhi (IN)

(21) Appl. No.: 14/304,536

(22) Filed: Jun. 13, 2014

(51) Int. Cl. G06Q 30/02; G06F 17/30

(52) U.S. Cl. CPC G06Q 30/0282; G06F 17/3053; G06F 17/30598

(57) ABSTRACT

A computer-implemented method for recommending a merchant to a consumer is implemented by a merchant evaluation computer system in communication with a memory. The method includes receiving a plurality of transaction data associated with a first merchant of a plurality of merchants, receiving a plurality of review data associated with the merchant, analyzing the plurality of transaction data and the plurality of review data to generate integrated consumption data at the merchant evaluation computer system, determining a relative ranking of the plurality of merchants by comparing integrated consumption data for each merchant of the plurality of merchants, and providing a ranked list of merchants to a consumer based at least in part on the relative ranking.

### BACKGROUND OF THE DISCLOSURE

The field of the disclosure relates generally to improving consumer decisions, and more specifically to methods and systems for identifying merchants for consumers.

In at least some examples, a consumer may wish to make purchasing decisions. Specifically, the consumer may be interested in identifying preferred merchants from whom they make purchases of goods and services. In some examples, the consumer identifies such preferred merchants based on prior knowledge, recommendations from others, and research. Such methods of identification are time-consuming. Further, in at least one example, a consumer is making purchasing decisions in an unfamiliar location. Such a consumer may be referred to as a “non-local consumer.” For example, the non-local consumer may be interested in identifying a preferred vendor for shopping, dining, entertainment, lodging, or any other goods or services. In such examples, the ability of the non-local consumer to identify preferred merchants may be decreased because the non-local consumer has comparatively little prior knowledge regarding preferred merchants. Accordingly, such non-local consumers may expend greater time to identify local merchants. Systems and methods of facilitating the identification of merchants may be beneficial.

### BRIEF DESCRIPTION OF THE DISCLOSURE

In one aspect, a computer-implemented method for recommending a merchant to a consumer is provided. The method is implemented by a merchant evaluation computer system in communication with a memory. The method includes receiving a plurality of transaction data associated with a first merchant of a plurality of merchants, receiving a plurality of review data associated with the merchant, analyzing the plurality of transaction data and the plurality of review data to generate integrated consumption data at the merchant evaluation computer system, determining a relative ranking of the plurality of merchants by comparing integrated consumption data for each merchant of the plurality of merchants, and providing a ranked list of merchants to a consumer based at least in part on the relative ranking.

In another aspect, a merchant evaluation computer system used to recommend a merchant to a consumer is provided. The mobile computing device includes a processor, and a memory coupled to the processor. The mobile computing device is configured to receive a plurality of transaction data associated with a first merchant of a plurality of merchants, receive a plurality of review data associated with the merchant, analyze the plurality of transaction data and the plurality of review data to generate integrated consumption data, determine a relative ranking of the plurality of merchants by comparing integrated consumption data for each merchant of the plurality of merchants, and provide a ranked list of merchants to a consumer based at least in part on the relative ranking.

In a further aspect, computer-readable storage media for recommending a merchant to a consumer is provided. The computer-readable storage media has computer-executable instructions embodied thereon. When executed by at least one processor, the computer-executable instructions cause the processor to receive a plurality of transaction data associated with a first merchant of a plurality of merchants, receive a plurality of review data associated with the merchant, analyze the plurality of transaction data and the plurality of review data to generate integrated consumption data, determine a relative ranking of the plurality of merchants by comparing integrated consumption data for each merchant of the plurality of merchants, and provide a ranked list of merchants to a consumer based at least in part on the relative ranking.

### BRIEF DESCRIPTION OF THE DRAWINGS

The figures listed below show example embodiments of the methods and systems described herein.

FIGS. 1-9 show example embodiments of the methods and systems described herein.

FIG. 1 is a schematic diagram illustrating an example multi-party payment card industry system for enabling ordinary payment-by-card transactions in which merchants and card issuers do not necessarily have a one-to-one relationship.

FIG. 2 is an expanded block diagram of an example embodiment of server architecture used in payment transactions in accordance with one example embodiment of the present disclosure.

FIG. 3 illustrates an is an expanded block diagram of an example embodiment of a computer server system architecture of a system used to recommend merchants to a consumer in accordance with one example embodiment of the present disclosure.

FIG. 4 is a simplified data flow diagram of an example consumer computing device used by a consumer seeking a recommendation of merchants in accordance with one example embodiment of the present disclosure.

FIG. 5 illustrates an example configuration of a server system such as the merchant evaluation computer system of FIGS. 2 and 3 used to recommend merchants to consumers in accordance with one example embodiment of the present disclosure.

FIG. 6 is a simplified data flow diagram of recommending merchants to consumers using the merchant evaluation computer system of FIGS. 2 and 3.

FIG. 7 is a simplified diagram of an example method of recommending merchants to consumers using the merchant evaluation computer system of FIGS. 2 and 3.

FIG. 8 is a simplified diagram of a further example method of recommending merchants to consumers using the merchant evaluation computer system of FIGS. 2 and 3.

FIG. 9 is a diagram of components of one or more example computing devices that may be used in the environment shown in FIG. 6.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of the embodiments of the disclosure refers to the accompanying drawings. The same reference numbers in different drawings may identify the same or similar elements. Also, the following detailed description does not limit the claims.

Described herein are computer systems such as merchant evaluation computer systems and consumer computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transactions card can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The subject matter described herein relates generally to improving consumer decisions, and more specifically to methods and systems for identifying merchants for consumers. Specifically, the methods and systems described herein include (i) receiving a plurality of transaction data associated with a first merchant of a plurality of merchants; (ii) receiving a plurality of review data associated with the merchant; (iii) analyzing the plurality of transaction data and the plurality of review data to generate integrated consumption data; (iv) determining a relative ranking of the plurality of merchants by comparing integrated consumption data for each merchant of the plurality of merchants; and (v) providing a ranked list of merchants to a consumer based at least in part on the relative ranking.

In at least some examples, consumers are cardholders (e.g., entities using a payment card such as a credit card, a debit card, or a prepaid card) that initiate transactions with merchants. In order to initiate such transactions, cardholders may first need to identify merchants with whom to conduct transactions. At least some consumers may wish to identify merchants with goods or services (“products”) that most closely correspond to the interests of the consumer. Consumers may be interested in identifying merchants with particular products, particular products of a particular characteristic or level of quality, and particular products at particular prices.

Some consumers may identify such merchants based on previous knowledge or personal recommendations. However, some consumers may require additional information to identify merchants. For example, some consumers may make purchasing decisions in an unfamiliar location. These consumers may be referred to as “non-local consumers.” For example, a non-local consumer may be interested in identifying a preferred vendor for shopping, dining, entertainment, lodging, or any other products. In such examples, the ability of the non-local consumer to identify preferred merchants may be decreased because the non-local consumer has comparatively little prior knowledge regarding nearby merchants and few parties from whom they may obtain a personal recommendation. In other examples, consumers may have limited previous knowledge or personal recommendations for other reasons. For example, such low-information consumers may have recently moved to a new area and not have prior experiences with nearby merchants. Such consumers may benefit from systems and methods as described herein.

In some cases, consumers document their experiences with merchants in the form of reviews or evaluations (“review data”). Such review data may include quantitative and qualitative evaluations of merchants in multiple dimensions. For example, consumers may evaluate merchants with numeric ratings or narrative evaluations. Such consumers may create or store review data in a plurality of locations on the web. For example, review data may be stored on various websites, applications, and other Internet-accessible services. Such various resources may be referred to as “review resources”. However, a non-local consumer may have difficulty identifying relevant information from review resources in order to inform their consumption decisions because of the time and difficulty involved in searching for such review data from multiple review resources. Further, review data may vary substantially from review resource to review resource. A particular review resource may contain review data with substantially different characteristics than other resources. Accordingly, consumers may face difficulties in attempting to compare review data from various review resources.

When consumers make purchase with merchants, transaction data is generated. Such transaction data may include amount spent, the products purchased, a numbers of products purchased, the location of transactions, and a date and time associated with such purchase. Such transaction data may also be processed to determine additional characteristics associated with the merchant. For instance, transaction data from a plurality of transactions may be aggregated to determine transaction frequency, average size of transaction, and transaction trends. Such characteristics may be useful for a consumer to understand the popularity of a merchant and its likelihood to provide suitable products. Accordingly, transaction data may be useful to assess a merchant as well as to determine days and times to make transactions with a merchant with reduced waiting times (i.e., less busy times for the merchant.) However, transaction data is generally unavailable to consumers.

The systems and methods described herein substantially facilitate improved identification of merchants to consumers by presenting recommendations for merchants to consumers based on processed transaction data and processed review data from a plurality of review resources. Processed review data and processed transaction data are combined together to create integrated consumption data which reflects characteristics of merchants (derived from transaction data) and evaluations of merchants (derived from review data). Integrated consumption data may be used to provide ranked recommendations of merchants to consumers. The ranked recommendation of merchants may help consumers such as non-local consumers to make purchasing decisions. In the example embodiment, the systems and methods described herein are facilitated by a merchant evaluation computer system.

The merchant evaluation computer system receives a plurality of transaction data associated with a plurality of merchants. The plurality of transaction data includes transaction records each associated with a particular transaction. Each transaction record is thus associated with a merchant and a consumer. In general, such transaction data, as described herein, refers to information related to a payment transaction between conducted by a cardholder and a merchant. Accordingly, in an example embodiment, transaction data may include a transaction amount, a merchant identifier, a primary account number (“PAN”) associated with the cardholder, a transaction time, and a merchant location. Further, additional information related to transactions may be included with transaction data and additionally received by the merchant valuation computer system. Such additional information may include other details related to the transaction including product identifiers, categories associated with products, promotional details or discounts related to the transaction, and any other suitable information.

Additionally, as noted above, other data may be inferred or extrapolated from transaction data by processing transaction data or comparing transaction data to databases. For example, a merchant category may be determined based upon identification of a merchant identifier used to group or associate a particular merchant with related merchants. In one illustration, the merchant evaluation computer system identifies a merchant identifier in transaction data and retrieves an associated record from a categorization database that categorizes merchants. Similarly, a merchant location category may be used to associate a particular merchant with a geographic region. Transaction data may also be used to determine, for example, popularity indicators (e.g., frequency of purchase, peak purchase times, and seasonality information), the average transaction cost for a merchant, the location of a merchant, seasonal or daily trends associated with a merchant, and other information related to a merchant. Such determinations may be referred to as transaction data determinations. In one example, popularity of a merchant may be determined based upon analyzing the volume of transactions at a merchant over a period of time. If the merchant transaction volume is increasing, the merchant may be regarded as increasing in popularity. If the merchant transaction volume peaks at particular days or times, seasonal trends may similarly be determined. Further, processing transaction data may allow merchant evaluation computer system to determine the average number of transactions per hour for a merchant. Comparisons of transaction values may be also used to determine statistical values associated with the merchant such as mean transaction values, mode transaction values, standard deviations of transaction values, and transaction value trends.

The merchant evaluation computer system also receives a plurality of review data. The plurality of review data includes review data records that are each associated with a particular review of at least one merchant. Review data may include quantitative ratings and qualitative ratings, or information related to the merchant including categorization data, pricing data, hours of operation data, and location data. Location data may include country information, city information, state information, address information, and zip code information. Pricing data may include predicted ranges of prices associated with goods and services for each merchant. For example, a hotel may have pricing data representative of a nightly room rate (as advertised) while a restaurant may have pricing data representative of a typical meal cost (based upon a menu). Hours of operation data may include, for example, hours of operation and days of operation associated with each merchant. The review data may also include listings of goods and services (“products”) available from a merchant along with associated prices. Further, review data may include promotional data or discount information for the merchant. Categorization information may include a merchant type. For instance, restaurants may be categorized as, “High Tier”, “Mid Tier”, “Low Tier”, “Casual Dining,”, and “Fast Food.” Alternately, restaurants may be categorized by a type of cuisine or atmosphere.

Quantitative ratings and qualitative ratings represent information describing the experience of a particular consumer with the particular merchant. For example, review data may include quantitative evaluations associated with the merchant in a variety of categories. In one example, merchants, merchant services, and merchant products are reviewed on numeric scales (e.g., scores from one to ten or star ratings from zero to five stars). In a second example, merchants, merchant services, and merchant products are rated with qualitative assessments (e.g., “Low”, “Medium”, and “High”, or “Poor”, “Average”, and “Excellent.”) Accordingly, review data may vary substantially in form and type. The merchant evaluation computer system facilitates the processing of review data into a consistent form that may be useful to recommend merchants to a consumer.

The quantitative and qualitative ratings may be associated with a variety of categories of attributes for a merchant. In an example embodiment associated with merchants that are bars and restaurants, qualitative and quantitative ratings are provided for an overall rating, a rating for service, a rating for menu choice, a rating for taste, a rating for cost, and a rating for ambience. In alternative embodiments associated with merchants that are bars and restaurants, additional attributes may be rated. Further, in other examples wherein the merchant is a hotel, different attributes may be rated and therefore associated qualitative and quantitative ratings may include an overall rating, a rating for bed quality, a rating for amenities, a rating for room service, and a rating for convenience to local attractions. Similarly, in other examples wherein the merchant is a retail merchant, different attributes may be rated and therefore associated qualitative and quantitative ratings may include an overall rating, a merchandising rating, a pricing rating, and a service rating.

As described above, review data may be stored on a plurality of review resources. In the example embodiment, review data is received from two types of review resources. The first type of review resource includes any externally available resources (“external review resources”) containing review data. External review resources generally refer to review resources that are available from internet web sites, web services, and web applications that are not primarily associated with the merchant evaluation computer system. As described below, review data may be received from such external review resources in several methods. The merchant evaluation computer system may utilize methods including web scraping and web crawling to extract information from external review resources. Alternately, merchant evaluation computer system may receive feeds of data from external review resources. For example, review data may be transmitted and received using Real Simple Syndication (“RSS”) feeds, atomic feeds, web services, or any other suitable methods.

The second type of review resource includes review resources associated with merchant evaluation computer system (“internal review resources.”) In one embodiment, such internal review resources are hosted and executed on the merchant evaluation computer system. In a second embodiment, internal review resources are hosted and executed on a computer system in communication with the merchant evaluation computer system. In either example, internal review resources substantially represent review resources associated with the cardholders described herein. More specifically, internal review resources are presented to cardholders to provide and view review data. Accordingly, review data from internal review resources represents review data from cardholders.

In at least one example, a cardholder may be prompted to provide review data to internal review resources based upon transaction data. More specifically, a cardholder may be prompted to review a merchant at internal review resources based upon a previous transaction with that merchant. In one example, a cardholder enrolls in a service enabling the cardholder to review merchants (i.e., the internal review resources). When the merchant evaluation computer system receives transaction data, it identifies transactions associated with account identifiers associated with accounts enrolled in the service. Upon identifying a transaction associated with an account enrolled in the service, the merchant evaluation computer system prompts a cardholder to review the merchant. More specifically, the merchant evaluation computer system retrieves contact information associated with the account provided by the cardholder during enrollment and sends a message or alert to the cardholder using the contact information. Accordingly, the merchant evaluation computer system facilitates engaging cardholders in creating review data for merchants after transactions with the merchants.

Received review data from review resources is processed by the merchant evaluation computer system. This processing represents converting qualitative ratings to quantitative ratings to facilitate comparisons. Such processing also represents aggregating review data for particular merchants and averaging them to determine qualitative and quantitative ratings for various attributes for each merchant based on a plurality of received review data. Therefore, in one example, a plurality of review data from external review resources (i.e., multiple customer reviews from multiple review services) is integrated with a plurality of review data from internal review resources (i.e., multiple customer reviews from the internal review resource) and used to determine combined ratings for each merchant in a plurality of attributes. The merchant evaluation computer system may average ratings from the aggregated review data to determine combined ratings for each attribute.

Merchant evaluation computer system analyzes the received plurality of transaction data and the plurality of review data to generate integrated consumption data. In a first example, merchant evaluation computer system normalizes received transaction data and normalizes review data to create consistency of transaction data and review data, respectively. For example, transaction data is processed and analyzed such that any suitable categorizations or evaluations described above are available for each merchant associated with transaction data. In the example embodiment, at least total amount spent with a merchant in a time period, the total amount of transactions at a merchant in a time period, and the total amount of cardholder accounts making transactions with a merchant in a time period are determined.

Further, review data is normalized such that qualitative assessments are converted into quantitative assessments and quantitative assessments are normalized to use comparable scales. For example, ratings of “Low”, “Medium”, and “High”, or “Poor”, “Average”, and “Excellent”, are compared to associated quantitative values and merchants rated using various scales (e.g., on scales of 1 to 5, 1 to 10, and 1 to 100) are re-scaled to ensure that data may be compared.

Upon normalizing review data and transaction data, merchant evaluation computer system further analyzes such data by applying a plurality of weights associated with attributes of normalized transaction data and normalized review data. Such weighting is described in more detail below. In one example, a merchant is a restaurant and is associated with review data attributes described above. Each attribute is associated with a particular weighting. Thus, the ratings for each attribute may be used to determine a total score. More specifically, review data attributes of overall rating, service rating, taste rating, menu rating, cost rating, and ambience rating are each associated with a weighting and used to calculate a total review score. In at least one example, distinct total review scores are determined for review data from internal review resources and external review resources.

As described below, although default weightings may be used for each attribute of review data, weightings may be adjusted. In one example, particular categories of merchants or particular locations of merchants may be associated with specific weightings. In another example, cardholders may provide their own weightings based on their preferences. In an additional example, cardholders may be assigned distinct weightings based on previously determined preferences based on transaction data.

In a similar fashion, attributes associated with normalized transaction data are weighted to determine a total transaction score. More specifically, in the example embodiment, the total amount spent with a merchant in a time period, the total amount of transactions at a merchant in a time period, and the total amount of cardholder accounts making transactions with a merchant in a time period are determined and associated with weights. Such attributes and weights are used to determine a total transaction score.

As with review data, although default weightings may be used for each attribute of transaction data, weightings may be adjusted in a variety of scenarios as described herein. The merchant evaluation computer system may determine distinct weightings based on cardholder preferences, merchant categories, and merchant locations.

The total transaction score and the total review score are further used to determine an overall score. In the example embodiment, the total transaction score and total review score are each weighted. As in other examples of weighting, such weighting may vary based on factors including cardholder preferences, merchant categories, and merchant locations. In some examples, total review score includes total internal review score (based on internal review resources) and total external review score (based on external review resources) and each component review score is weighted separately and used with a weighted total transaction score to determine an overall score.

Accordingly, the merchant evaluation computer system may determine overall scores for each merchant identified in received transaction data and received review data. Further, such overall scores may vary, depending upon the weighting method used, for various categories of merchants and various cardholders. In the example embodiment, transaction data, review data, scores, and weights are all stored at the merchant evaluation computer system for each merchant as merchant data. Merchant data for each merchant is associated with at least a merchant category, a merchant location, and merchant attributes.

A consumer further may access a service associated with the merchant evaluation computer system (“merchant evaluation service”) and view information related to a variety of merchants based on the processed transaction data and the processed review data. Merchant evaluation service represents a web service that provides merchant recommendations to consumers. In one example, the merchant evaluation service is a website. In another example, the merchant evaluation service is an application such as a mobile application.

In the example embodiment a consumer sends a merchant recommendation request to the merchant evaluation computer system by using a computing device to interact with the merchant evaluation service. In the example embodiment, the merchant recommendation request includes a location of interest, at least one merchant category of interest, and a plurality of consumer preferences to the merchant evaluation service. In at least one example the location of interest is provided based upon a determined location of the consumer. The location of interest may be determined by a consumer computing device providing a present location of the consumer using location services. Such location services may include using any known method of location identification including GPS, beacons, and triangulation. In the example embodiment, location services are only utilized when the consumer allows merchant evaluation service to access consumer computing device location services. Location of interest may be designated at a variety of levels including a country or national level, a state level, a metropolitan area or designated market area (“DMA”), a city level, a zip code level, a street level, and a neighborhood level.

Merchant category of interest may indicate a type of merchant in broad or narrow senses. For example, the consumer may search for “restaurants” and retrieve a ranked list of restaurants that satisfy the location of interest and consumer preferences. Alternately, the consumer may search for “Italian restaurants” and retrieve a ranked list of only Italian restaurants satisfying the location of interest and consumer preferences.

Consumer preferences may indicate additional factors of interest to the consumer. Consumer preferences may include, for example, pricing preferences (e.g., the expected cost of a transaction with the merchant), time preferences (e.g., the available time for the consumer to interact with the merchant), and quality preferences. In some examples some consumers may have additional preferences such as dietary preferences. In one example, the plurality of consumer preferences are provided based upon previously identified consumer preferences. For example, based on previous searches stored at the merchant evaluation service, consumer preferences may be determined. Alternately, a consumer may elect to pre-select known preferences that are stored at merchant evaluation service and used to retrieve consumer preferences.

Based upon the merchant recommendation request, possible merchants are identified by the merchant evaluation computer system. Further, if consumer information or merchant categorization indicates that specific weightings should apply to such merchants, those weightings are retrieved and applied to merchant data associated with each relevant merchant. Merchant evaluation service provides a list of merchants, ranked based upon overall scores, to the consumer. Accordingly, the merchant evaluation computer system filters for merchants that satisfy location of interest, category of interest, and consumer preferences and ranks the remaining merchants according to weighted overall score. Consumer may accordingly select from the provided ranked list.

A technical effect of the systems and methods described herein include at least one of (a) improving the identification of attractive merchants to consumers in unfamiliar locations; (b) improving customer attraction of merchants by providing customers with lists of suitable merchants corresponding to consumer interests; and (c) reducing the time expended by consumers in identifying merchants.

More specifically, the technical effects can be achieved by performing at least one of the following steps: (a) receiving a plurality of transaction data associated with a first merchant of a plurality of merchants; (b) receiving a plurality of review data associated with the merchant; (c) analyzing, at the merchant evaluation computer system, the plurality of transaction data and the plurality of review data to generate integrated consumption data; (d) determining a relative ranking of the plurality of merchants by comparing integrated consumption data for each merchant of the plurality of merchants; (e) providing a ranked list of merchants to a consumer based at least in part on the relative ranking; (f) scanning a plurality of external review resources for review data associated with the merchant; (g) extracting review data from the plurality of external review resources; (h) requesting review data from a cardholder; (i) requesting review data from the cardholder based upon at least a portion of the received plurality of transaction data; (j) identifying a plurality of merchant values for the merchant, each of the plurality of merchant values associated with a review category, assigning a weight to each of the plurality of review categories, and weighting each of the merchant values based upon the assigned weights; (k) ranking the merchant within the plurality of merchants based, at least in part, on the weighted merchant values; (l) identifying a merchant category associated with the merchant, wherein the merchant category is further associated with a plurality of merchants, associating the merchant with the merchant category, and ranking the merchant within the plurality of merchants of the merchant category; and (m) receiving at least one cardholder preference and providing the ranked list of merchants to the cardholder based on the at least one cardholder preference.

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the determination and analysis of characteristics of devices used in payment transactions.

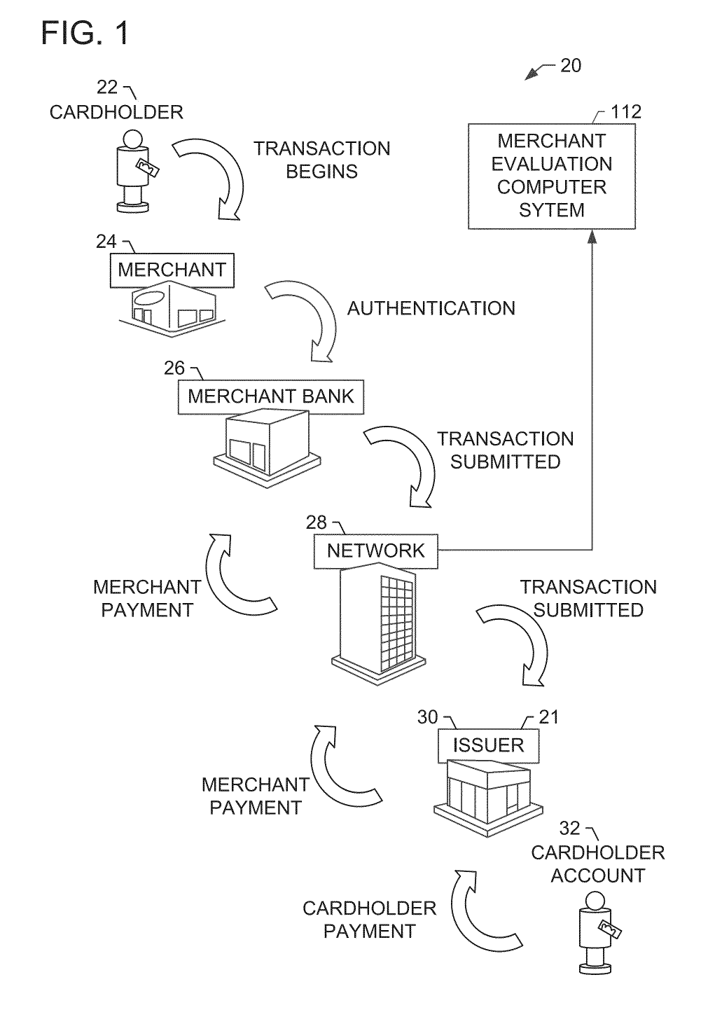

FIG. 1 is a schematic diagram illustrating an example multi-party transaction card industry system 20 for enabling ordinary payment-by-card transactions, including payment-by-card transactions made by cardholders using cardholder computing devices to initiate transactions at an online merchant, in which merchants 24 and card issuers 30 do not need to have a one-to-one special relationship. Typical financial transaction institutions provide a suite of interactive, online applications to both current and prospective customers. For example, a financial transactions institution may have a set of applications that provide informational and sales information on their products and services to prospective customers, as well as another set of applications that provide account access for existing cardholders.

Embodiments described herein may relate to a transaction card system, such as a credit card payment system using the MasterCard® interchange network. The MasterCard® interchange network is a set of proprietary communications standards promulgated by MasterCard International Incorporated® for the exchange of financial transaction data and the settlement of funds between financial institutions that are members of MasterCard International Incorporated®. (MasterCard is a registered trademark of MasterCard International Incorporated located in Purchase, N.Y.).

In a typical transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authorization from a merchant bank 26 for the amount of the purchase. The request may be performed over the telephone or electronically, but is usually performed through the use of a point-of-sale terminal, which reads cardholder's 22 account information from a magnetic stripe, a chip, or embossed characters on the transaction card and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether cardholder's 22 account 32 is in good standing and whether the purchase is covered by cardholder's 22 available credit line. Based on these determinations, the request for authorization will be declined or accepted. If the request is accepted, an authorization code is issued to merchant 24.

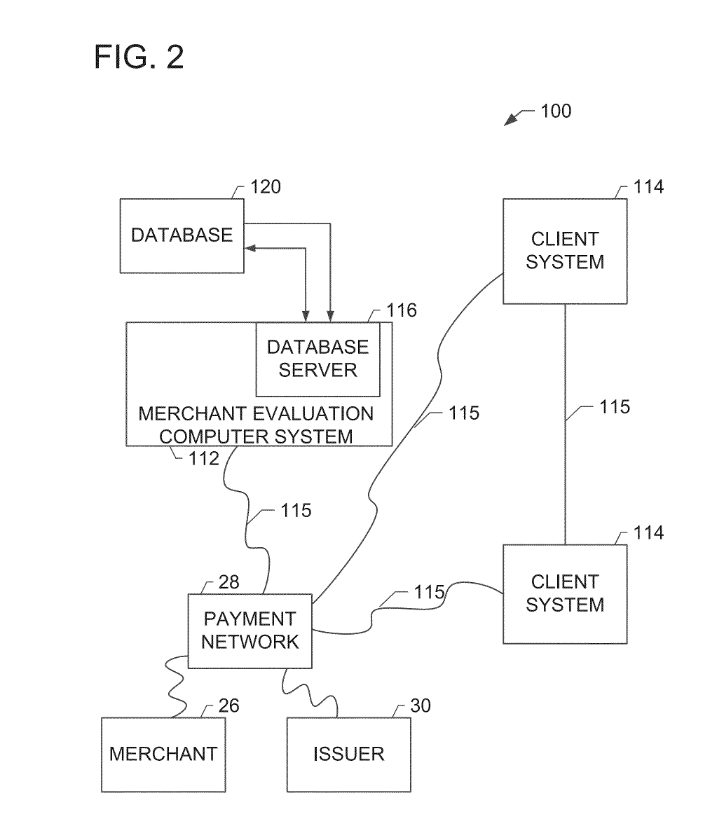

When a request for authorization is accepted, the available credit line of cardholder's 22 account 32 is decreased. Normally, a charge for a payment card transaction is not posted immediately to cardholder's 22 account 32 because bankcard associations, such as MasterCard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction card information, such as a type of merchant, amount of purchase, date of purchase, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. In the example embodiment, transaction data including such additional transaction data may also be provided to systems including merchant evaluation computer system 112. In the example embodiment, interchange network 28 provides such transaction data and additional transaction data. In alternative embodiments, any party may provide such data to merchant evaluation computer system 112.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and interchange network 28, and then between interchange network 28 and merchant bank 26, and then between merchant bank 26 and merchant 24.

As described below in more detail, merchant evaluation computer system 112 may be used to recommend merchants such as merchant 24 to consumers such as cardholder 22 using transaction data received from, for example, interchange network 28. Although the systems described herein are not intended to be limited to facilitate such applications, the systems are described as such for exemplary purposes.

FIG. 2 is a simplified block diagram of an example computer system 100 used to recommend merchants to consumers in accordance with the present disclosure. In the example embodiment, system 100 is used for receiving a plurality of transaction data associated with a first merchant of a plurality of merchants, receiving a plurality of review data associated with the merchant, analyzing, at the merchant evaluation computer system, the plurality of transaction data and the plurality of review data to generate integrated consumption data, determining a relative ranking of the plurality of merchants by comparing integrated consumption data for each merchant of the plurality of merchants, and providing a ranked list of merchants to a consumer based at least in part on the relative ranking, as described herein. In other embodiments, the applications may reside on other computing devices (not shown) communicatively coupled to system 100, and may recommend merchants to consumers using system 100.

More specifically, in the example embodiment, system 100 includes a merchant evaluation computer system 112, and a plurality of client sub-systems, also referred to as client systems 114, connected to merchant evaluation computer system 112. In one embodiment, client systems 114 are computers including a web browser, such that merchant evaluation computer system 112 is accessible to client systems 114 using the Internet. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) as well as external systems used to store review data (“external review resources”). Merchant evaluation computer system 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail. In one embodiment, centralized database 120 is stored on merchant evaluation computer system 112 and can be accessed by potential users at one of client systems 114 by logging onto merchant evaluation computer system 112 through one of client systems 114. In an alternative embodiment, database 120 is stored remotely from merchant evaluation computer system 112 and may be non-centralized.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with acquirer bank 26 (shown in FIG. 1) while another one of client systems 114 may be associated with issuer bank 30 (shown in FIG. 1). Merchant evaluation computer system 112 may be associated with interchange network 28. In the example embodiment, merchant evaluation computer system 112 is associated with a network interchange, such as interchange network 28, and may be referred to as an interchange computer system. Merchant evaluation computer system 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

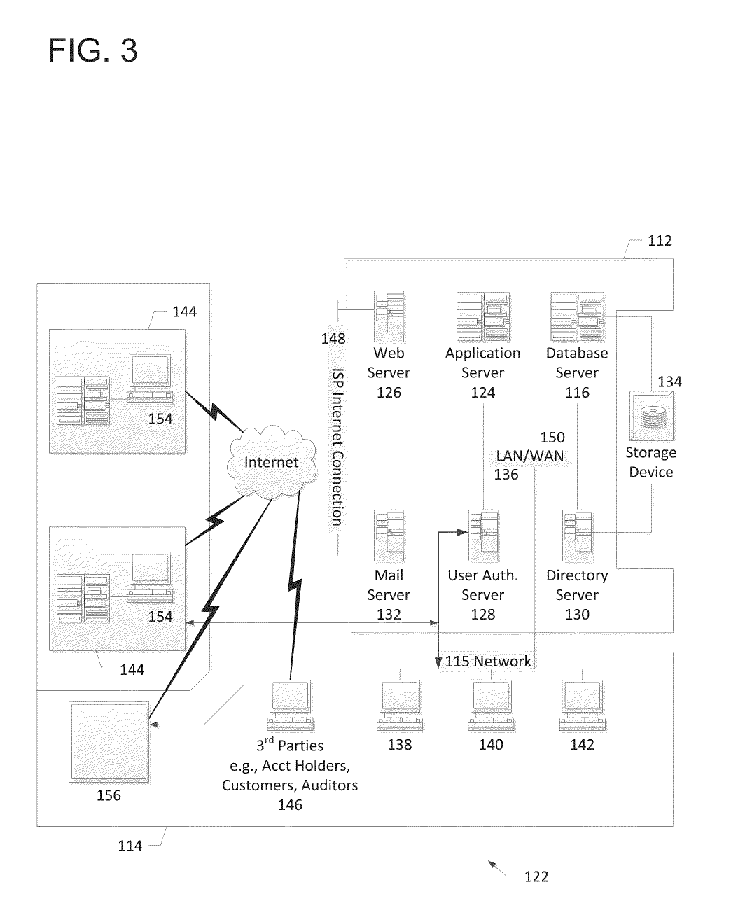

FIG. 3 is an expanded block diagram of an example embodiment of a computer server system architecture of a processing system 122 used to recommend merchants to consumers in accordance with one embodiment of the present disclosure. Components in system 122, identical to components of system 100 (shown in FIG. 2), are identified in FIG. 3 using the same reference numerals as used in FIG. 2. System 122 includes merchant evaluation computer system 112, client systems 114, and payment systems 118. Merchant evaluation computer system 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Merchant evaluation computer system 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Merchant evaluation computer system 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with merchant evaluation computer system 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with merchant evaluation computer system 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

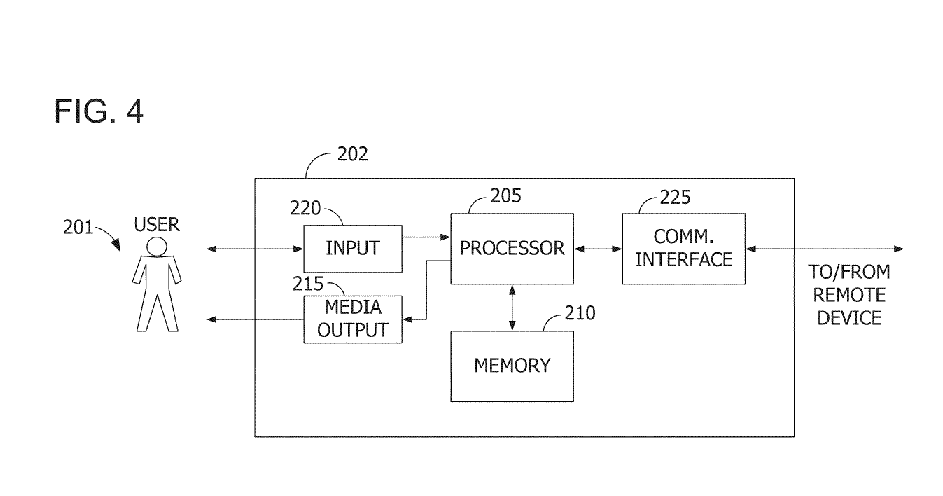

FIG. 4 illustrates an example configuration of a user system 202 operated by a user 201, such as cardholder 22 (shown in FIG. 1). User system 202 may be used by a consumer to interact with merchant evaluation computer system 112 and, more specifically, to access merchant evaluation service to identify merchants recommended to cardholder 22. User system 202 may include, but is not limited to, client systems 114, 138, 140, and 142, payment systems 118, workstation 154, and manager workstation 156 (shown in FIG. 3). In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information such as executable instructions and/or written works to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 215 and input device 220. User system 202 may also include a communication interface 225, which is communicatively couplable to a remote device such as merchant evaluation computer system 112. Communication interface 225 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from merchant evaluation computer system 112. A client application allows user 201 to interact with a server application from merchant evaluation computer system 112 such as merchant evaluation service.

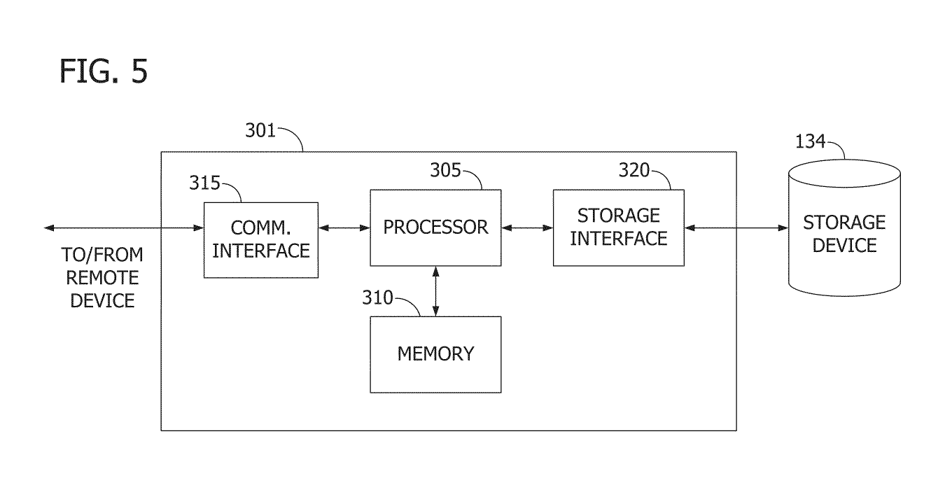

FIG. 5 illustrates an example configuration of a server system 301 such as merchant evaluation computer system 112 (shown in FIGS. 2 and 3). Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

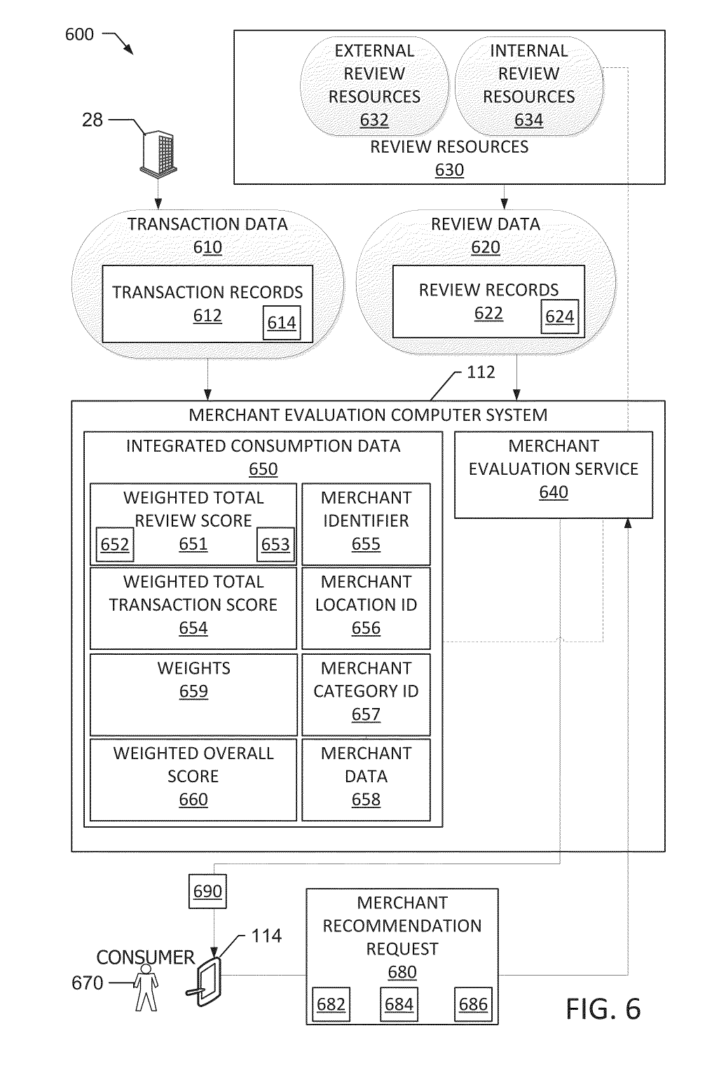

FIG. 6 is a simplified data flow diagram 600 of recommending merchants to consumers using merchant evaluation computer system 112 of FIGS. 2 and 3. Merchant evaluation computer system 112 receives a plurality of transaction data 610. In the example embodiment, plurality of transaction data 610 is received from interchange network 28. In alternative embodiments, any transaction parties 24, 26, 28, and 30 may provide plurality of transaction data 610. Plurality of transaction data 610 includes transaction records 612 each associated with a particular transaction. Each transaction record 612 is thus associated with a merchant 24 (shown in FIG. 1) and a consumer such as cardholder 22 (shown in FIG. 1) and accordingly includes a transaction merchant identifier 614. In general, such transaction data 610, as described herein, refers to information related to a payment transaction between conducted by cardholder 22 and merchant 24. Accordingly, in an example embodiment, transaction data 610 may include a transaction amount, a merchant identifier, a primary account number (“PAN”) associated with the cardholder, a transaction time, and a merchant location. Further, additional information related to transactions may be included with transaction data 610 and additionally received by merchant valuation computer system 112. Such additional information may include other details related to the transaction including product identifiers, categories associated with products, promotional details or discounts related to the transaction, and any other suitable information.

Additionally, other data may be inferred or extrapolated from transaction data 610 by processing transaction data 610 or comparing transaction data 610 to databases. For example, a merchant category may be determined based upon identification of a merchant identifier used to group or associate a particular merchant 24 with related merchants 24. In one illustration, merchant evaluation computer system 112 identifies a merchant identifier in transaction data 610 and retrieves an associated record from a categorization database that categorizes merchants 24. Similarly, a merchant location category may be used to associate a particular merchant 24 with a geographic region. Alternately, a merchant location category may be derived from analyzing the merchant location (e.g., identifying a region based on an address or postal code), Transaction data 610 may also be used to determine, for example, popularity indicators (e.g., frequency of purchase, peak purchase times, and seasonality information), the average transaction cost for a merchant 24, the location of a merchant 24, seasonal or daily trends associated with a merchant 24, and other information related to a merchant 24. Such determinations may be referred to as transaction data determinations. In one example, popularity of a merchant 24 may be determined based upon analyzing the volume of transactions at a merchant 24 over a period of time. If merchant transaction volume is increasing, merchant 24 may be regarded as increasing in popularity. If merchant transaction volume peaks at particular days or times, seasonal trends may similarly be determined. Further, processing transaction data 610 may allow merchant evaluation computer system 112 to determine the average number of transactions per hour for merchant 24. Comparisons of transaction values may be also used to determine statistical values associated with merchant 24 such as mean transaction values, mode transaction values, standard deviations of transaction values, and transaction value trends.

Merchant evaluation computer system 112 also receives a plurality of review data 620. Plurality of review data 620 includes review records 622 that are each associated with a particular review of at least one merchant 24 identified with a review merchant identifier 624. Review data 620 may include quantitative ratings and qualitative ratings, or information related to merchant 24 including categorization data, pricing data, hours of operation data, and location data. Location data may include country information, city information, state information, address information, and zip code information. Pricing data may include predicted ranges of prices associated with goods and services for each merchant. For example, a hotel may have pricing data representative of a nightly room rate (as advertised) while a restaurant may have pricing data representative of a typical meal cost (based upon a menu). Hours of operation data may include, for example, hours of operation and days of operation associated with each merchant 24. Review data 620 may also include listings of goods and services (“products”) available from merchant 24 along with associated prices. Further, review data 620 may include promotional data or discount information for merchant 24. Categorization information may include a merchant type. For instance, restaurants may be categorized as, “High Tier”, “Mid Tier”, “Low Tier”, “Casual Dining,”, and “Fast Food.” Alternately, restaurants may be categorized by a type of cuisine or atmosphere.

Quantitative ratings and qualitative ratings represent information describing the experience of a particular consumer with the particular merchant 24. For example, review data 620 may include quantitative evaluations associated with merchant 24 in a variety of categories. In one example, merchant 24 s, merchant services, and merchant products are reviewed on numeric scales (e.g., scores from one to ten or star ratings from zero to five stars). In a second example, merchants 24, merchant services, and merchant products are rated with qualitative assessments (e.g., “Low”, “Medium”, and “High”, or “Poor”, “Average”, and “Excellent.”) In a third example, attributes associated with merchants 24 or merchant products may be evaluated in quantitative or qualitative matters. These attributes are indicated in the following paragraph and may include, for example, overall ratings, service ratings, cost ratings, and ambience ratings. Accordingly, review data 620 may vary substantially in form and type. Merchant evaluation computer system 112 facilitates the processing of review data 620 into a consistent form that may be useful to recommend merchants 24 to consumer such as cardholder 22.

The quantitative and qualitative ratings may be associated with a variety of categories of attributes for a merchant 24. In an example embodiment associated with merchants 24 that are bars and restaurants, qualitative and quantitative ratings are provided for an overall rating, a rating for service, a rating for menu choice, a rating for taste, a rating for cost, and a rating for ambience. In alternative embodiments associated with merchants 24 that are bars and restaurants, additional attributes may be rated. Further, in other examples wherein merchant 24 is a hotel, different attributes may be rated and therefore associated qualitative and quantitative ratings may include an overall rating, a rating for bed quality, a rating for amenities, a rating for room service, and a rating for convenience to local attractions. Similarly, in other examples wherein merchant 24 is a retail merchant, different attributes may be rated and therefore associated qualitative and quantitative ratings may include an overall rating, a merchandising rating, a pricing rating, and a service rating.

As described above, review data 620 may be stored on a plurality of review resources 630. In the example embodiment, review data 620 is received from two types of review resources 630. The first type of review resource includes any externally available resources, external review resources 632, containing review data 620. External review resources 632 generally refer to review resources 630 that are available from internet web sites, web services, and web applications that are not primarily associated with merchant evaluation computer system 112. Review data 620 may be received from such external review resources 632 in several methods. Merchant evaluation computer system 112 may utilize methods including web scraping and web crawling to extract information from external review resources 632. For example, a web crawler running on merchant evaluation computer system 112 may identify resources containing review data 620 associated with merchant 24 and accordingly use scraping methods to extract data from such external review resources 632. Alternately, merchant evaluation computer system 112 may receive feeds of data from external review resources 632. For example, review data 620 may be transmitted and received using Real Simple Syndication (“RSS”) feeds, atomic feeds, web services, or any other suitable methods.

The second type of review resource 630 is associated with merchant evaluation computer system 112. Such internal review resources 634 are hosted and executed on merchant evaluation computer system 112. In a second embodiment, internal review resources 634 are hosted and executed on a computer system in communication with merchant evaluation computer system 112. In either example, internal review resources 634 substantially represent review resources 630 associated with cardholders 22 described herein. More specifically, internal review resources 634 are presented to cardholders 22 to provide and view review data 620. Accordingly, review data 620 from internal review resources represents review data 620 from cardholders.

In at least one example, a cardholder may be prompted to provide review data 620 to internal review resources 634 based upon transaction data 610. More specifically, cardholder 22 may be prompted to review merchant 24 using merchant evaluation service 640 based upon a previous transaction between cardholder 22 and merchant 24. Merchant evaluation service 640 represents a service provided by merchant evaluation computer system 112 to enable cardholders 22 and consumers to be provided with merchant recommendations and to provide review data 620 related to merchants 24. In one example, cardholder 22 enrolls in merchant evaluation service 640 enabling cardholder 22 to review merchants 24 and thereby provide generated review data 620 to internal review resources 634. When merchant evaluation computer system 112 receives transaction data 610, it may identify transactions associated with account identifiers associated with accounts enrolled in merchant evaluation service 640. Upon identifying a transaction associated with an account enrolled in merchant evaluation service 640, merchant evaluation computer system 112 prompts cardholder 22 to review merchant 24. More specifically, merchant evaluation computer system 112 retrieves contact information associated with the account provided by cardholder 22 during enrollment and sends a message or alert to cardholder 22 using the contact information. Accordingly, merchant evaluation computer system 112 facilitates engaging cardholders 22 in creating review data 620 for merchants 24 after cardholder 22 engages in transactions with merchants 24.

Received review data 620 from review resources 630 is processed by merchant evaluation computer system 112. This processing represents converting qualitative ratings to quantitative ratings to facilitate comparisons. Such processing also represents aggregating review data 620 for particular merchants 24 and averaging them to determine qualitative and quantitative ratings for various attributes for each merchant 24 based on a plurality of received review data 620. Therefore, in one example, a plurality of review data 620 from external review resources 632 is integrated with a plurality of review data 620 from internal review resources 634 and used to determine combined ratings for each merchant 24 in a plurality of attributes. Merchant evaluation computer system 112 may average ratings from the aggregated review data 620 to determine combined ratings for each attribute.

Merchant evaluation computer system 112 analyzes the received plurality of transaction data 610 and the plurality of review data 620 to generate integrated consumption data 650. Integrated consumption data 650 includes a weighted total review score 651, a weighted total transaction score 654, and a weighted overall score 660. As described below, weighted total review score 651 may include a weighted total external review score 652 associated with external review resources 632 and a weighted total internal review score 653 associated with internal review resources 634. Integrated consumption data 650 is associated with merchant identifier 655, merchant location identifier 656, merchant category identifier 657, and merchant data 658, described below. Integration consumption data 650 also is associated with weights 659 that are used to generate weighted total review score 651, weighted total external review score 652, weighted total internal review score 653, weighted total transaction score 654, and weighted overall score 660. In a first example, merchant evaluation computer system 112 normalizes received transaction data 610 and normalizes review data 620 to create consistency of transaction data 610 and review data 620, respectively. For example, transaction data 610 is processed and analyzed such that any suitable categorizations or evaluations described above are available for each merchant associated with transaction data 610. In the example embodiment, at least total amount spent with a merchant in a time period, the total amount of transactions at a merchant in a time period, and the total amount of cardholder accounts making transactions with a merchant in a time period are determined.

Further, review data 620 is normalized such that qualitative assessments are converted into quantitative assessments and quantitative assessments are normalized to use comparable scales. For example, ratings of “Low”, “Medium”, and “High”, or “Poor”, “Average”, and “Excellent”, are compared to associated quantitative values and merchants rated using various scales (e.g., on scales of 1 to 5, 1 to 10, and 1 to 100) are re-scaled to ensure that data may be compared. In one example, qualitative ratings may processed to determine quantitative ratings using the mapping shown below (Table 1):

TABLE 1

| Variable | Range | | | | |
|---|---|---|---|---|---|
| Rating | 1 | 2 | 3 | 4 | 5 |
| Service | “Bad”, | “Average”, | “Good”, | “Very | “Amazing”, |
| | “Worst” = 1 | “NA” = 2 | “Fine”, | Good”, | “Excellent”, |
| | | | “Decent”, | “Great” = 4 | “Superb” = 5 |
| | | | “Nice” = 3 | | |
| Taste & | “Bad”, | “Average”, | “Good”, | “Very | “Amazing”, |
| Menu | “Worst” = 1 | “NA” = 2 | “Fine”, | Good”, | “Excellent”, |
| Choice | | | “Decent”, | “Great” = 4 | “Superb” = 5 |
| | | | “Nice” = 3 | | |
| Cost | “Very | “Average”, | “Good”, | “Very | “Amazing”, |
| | High”, | “NA” = 2 | “Fine”, | Good”, | “Excellent”, |
| | “High”, | | “Decent”, | “Great” = 4 | “Superb” = 5 |
| | “Not | | “Nice”, | | |
| | Worth It” = 1 | | “Economical” = 3 | | |
| Ambience | “Bad”, | “Average”, | “Good”, | “Very | “Amazing”, |
| | “Worst” = 1 | “NA” = 2 | “Fine”, | Good”, | “Excellent”, |
| | | | “Decent”, | “Great” = 4 | “Superb” = 5 |
| | | | “Nice” = 3 | | |

Accordingly, such a comparison table may be used by merchant evaluation computer system 112 to translate qualitative assessments like “Good” to quantitative assessments like “3 out of 5.” In other examples, language processing methods may be used to determine sentiment. Such language processing may be used where review data 620 is either lengthy or noncompliant with mapping systems such as the one shown in Table 1. Resealing may be achieved using similar methods. For example, when one set of review data 620 is on a scale of zero to ten and a second set of review data 620 is on a scale of zero to five, the second set of review data may be resealed by multiplying all rating information in review data by two.

Upon normalizing review data 620 and transaction data 610, merchant evaluation computer system 112 further analyzes such data by applying a plurality of weights from weights 659 associated with attributes of normalized transaction data 610 and normalized review data 620. Such weighting is described in more detail below. In one example, a merchant 24 is a restaurant and is associated with review data 620 attributes described above. Each attribute is associated with a particular weighting identified in weights 659. Thus, the ratings for each attribute may be used to determine a total score. More specifically, review data 620 attributes of overall rating, service rating, taste rating, menu rating, cost rating, and ambience rating are each associated with a weighting from weights 659 and used to calculate a total review score. For example, the weighting of review data 620 may be indicated as below (Table 2):

TABLE 2

| | Merchant 1 | Merchant 2 | Merchant 3 | Merchant 4 | Merchant 5 | Weight |
|---|---|---|---|---|---|---|
| Overall Rating | .625 | .938 | 1.563 | 1.25 | .625 | .4 |
| Service Rating | .385 | .769 | 1.154 | 1.538 | 1.154 | .1 |
| Taste Rating | .909 | .455 | 2.273 | .909 | .455 | .20 |
| Cost Rating | .385 | 1.154 | 1.154 | 1.154 | 1.154 | .20 |
| Ambience | .313 | .938 | 1.563 | 1.250 | .938 | .10 |
| Rating | | | | | | |
| Weighted Total | .578 | .867 | 1.582 | 1.191 | .781 | 1.00 |
| Review Score | | | | | | |

In at least one example, distinct weighted total external review scores 652 and weighted total internal review scores 653 are determined for review data 620 from external review resources 632 and internal review resources 634.

As described below, although default weightings may be used for each attribute of review data 620, weightings may be adjusted. In one example, particular categories of merchants 24 or particular locations of merchants 24 may be associated with specific weightings. In another example, cardholders 22 may provide their own weightings based on their preferences. In an additional example, cardholders 22 may be assigned distinct weightings based on previously determined preferences based on transaction data 610.

In a similar fashion, attributes associated with normalized transaction data 610 are weighted to determine a total transaction score. More specifically, in the example embodiment, the total amount spent with a merchant in a time period, the total amount of transactions at a merchant in a time period, and the total amount of cardholder accounts making transactions with a merchant in a time period are determined and associated with weights. Such attributes and weights are used to determine a total transaction score. For example, the weighting of transaction data 610 may be indicated as below (Table 3):

TABLE 3

| | Merchant 1 | Merchant 2 | Merchant 3 | Merchant 4 | Merchant 5 | Weight |
|---|---|---|---|---|---|---|
| Total | 70 | 113 | 49 | 141 | 127 | .4 |
| Amount | | | | | | |
| Spent | | | | | | |
| Total | 57 | 115 | 144 | 69 | 115 | .3 |
| Number of | | | | | | |
| Transactions | | | | | | |
| Total | 95 | 71 | 119 | 48 | 167 | .3 |
| Number of | | | | | | |
| Transacting | | | | | | |
| Accounts | | | | | | |
| Weighted | .740 | 1.010 | .985 | .913 | 1.352 | |
| Total | | | | | | |
| Transaction | | | | | | |
| Score | | | | | | |

As with review data 620, although default weightings may be used for each attribute of transaction data 610, weightings may be adjusted in a variety of scenarios as described herein. Merchant evaluation computer system 112 may determine distinct weightings based on cardholder preferences, merchant categories, and merchant locations.

Weighted transaction score 654 and weighted total review score 651 are used to determine an overall score. In the example embodiment, weighted total transaction score 654 and weighted total review score 651 are each weighted using weights 659. Such weighting may vary based on factors including cardholder preferences, merchant categories, and merchant locations. In some examples, weighted total review score 651 includes weighted total external review score 652 and weighted total internal review score 653 and each is weighted separately and used with a weighted total transaction score 654 to determine a weighted overall score 660. An example of weighting total external review score 652 and weighted total internal review score 653 along with weighted total transaction score 654 is shown below (Table 4):

TABLE 4

| | Merchant 1 | Merchant 2 | Merchant 3 | Merchant 4 | Merchant 5 | Weights |
|---|---|---|---|---|---|---|
| Weighted Total | .578 | .867 | 1.582 | 1.191 | .781 | .3 |
| External Review | | | | | | |
| Score | | | | | | |
| Weighted Total | .740 | 1.010 | .985 | .913 | 1.352 | .6 |
| Internal Review | | | | | | |
| Score | | | | | | |
| Weighted Total | .710 | 1.020 | 1.000 | .921 | 1.25 | .1 |
| Transaction Score | | | | | | |
| Weighted Overall | .688 | .968 | 1.166 | .997 | 1.171 | |
| Score | | | | | | |

Thus, in the example of Table 4, Merchant 5 has the highest overall score and will thus be the most preferred merchant 24 of the scored merchants 24. As described below, merchants 24 may be ranked based on such scoring and such rankings are used in identifying merchants 24 to consumers.

Accordingly, merchant evaluation computer system 112 may determine weighted overall scores 660 for each merchant 24 identified in received transaction data 610 and received review data 620. Further, such weighted overall scores 660 may vary, depending upon the weighting method used (and identified in weights 659), for various categories of merchants and various cardholders 22.

As shown, in the example embodiment, transaction data 610 and review data 620 are in merchant data 658. Thus merchant data 658 is stored along with, scores 651, 652, 653, 654, and 660, merchant identifiers 655, merchant location identifier 656, and merchant category identifier 657. Merchant data 658 for each merchant 24 is therefore associated with at least a merchant category, a merchant location, and merchant attributes. All such integrated consumption data 650 may be stored at memory 310 (shown in FIG. 4) of merchant evaluation computer system 112 or at a database such as database 120 (shown in FIG. 2) and served by database server 116 (shown in FIG. 2).

Consumer 670 further may access merchant evaluation service 640 associated with merchant evaluation computer system 112 and view information included in integrated consumption data 650 related to a variety of merchants 24. Merchant evaluation service 640 represents a web service that provides merchant recommendations to consumers 670. In one example, merchant evaluation service 640 is a website. In another example, merchant evaluation service 640 is an application such as a mobile application.

In the example embodiment consumer 670 sends a merchant recommendation request 680 to merchant evaluation computer system 112 by using a computing device such as client system 114 to interact with merchant evaluation service 640. In the example embodiment, the merchant recommendation request 680 includes a location of interest 682, at least one merchant category of interest 684, and a plurality of consumer preferences 686 to merchant evaluation service 640 at merchant evaluation computer system 112. In at least one example location of interest 682 is provided based upon a determined location of consumer 670. Location of interest 682 may be determined by client system 114 providing a present location of consumer 670 using location services. Such location services may include using any known method of location identification including GPS, beacons, and triangulation. In the example embodiment, location services are only utilized when consumer 670 allows merchant evaluation service 640 at merchant evaluation computer system 112 to access location services of client system 114. Location of interest 682 may be designated at a variety of levels including a country or national level, a state level, a metropolitan area or designated market area (“DMA”), a city level, a zip code level, a street level, and a neighborhood level.

Merchant category of interest 684 may indicate a type of merchant in broad or narrow senses. For example, consumer 670 may search for “restaurants” and retrieve a ranked list of restaurants that satisfy location of interest 682 and consumer preferences 686. Alternately, consumer 670 may search for “Italian restaurants” and retrieve a ranked list of only Italian restaurants satisfying location of interest 682 and consumer preferences 686.

Consumer preferences 686 may indicate additional factors of interest to consumer 670. Consumer preferences 686 may include, for example, pricing preferences (e.g., the expected cost of a transaction with the merchant), time preferences (e.g., the available time for the consumer to interact with the merchant), and quality preferences. In some examples some consumers 670 may have additional preferences such as dietary preferences. In another example, plurality of consumer preferences 686 are provided based upon previously identified consumer preferences. For example, based on previous searches stored at merchant evaluation service 640, consumer preferences 686 may be determined. Alternately, consumer 670 may elect to pre-select known preferences that are stored at merchant evaluation service 640 and used to retrieve consumer preferences 686.

Based upon merchant recommendation request 680, possible merchants 24 are identified by merchant evaluation computer system 112. Further, if consumer preferences 686 or merchant category identifier 657 indicates that specific weightings 659 should apply to such merchants 24, those weightings 659 are retrieved and applied to calculate weighted overall score 660. Merchant evaluation service 640 provides a ranked list 690 of merchants 24, ranked based upon weighted overall scores 660, to consumer 670. Accordingly, merchant evaluation computer system 112 filters for merchants 24 that satisfy location of interest 682, category of interest 684, and consumer preferences 686 and ranks remaining merchants 24 according to weighted overall score 660. Consumer 670 may accordingly select from the provided ranked list 690.

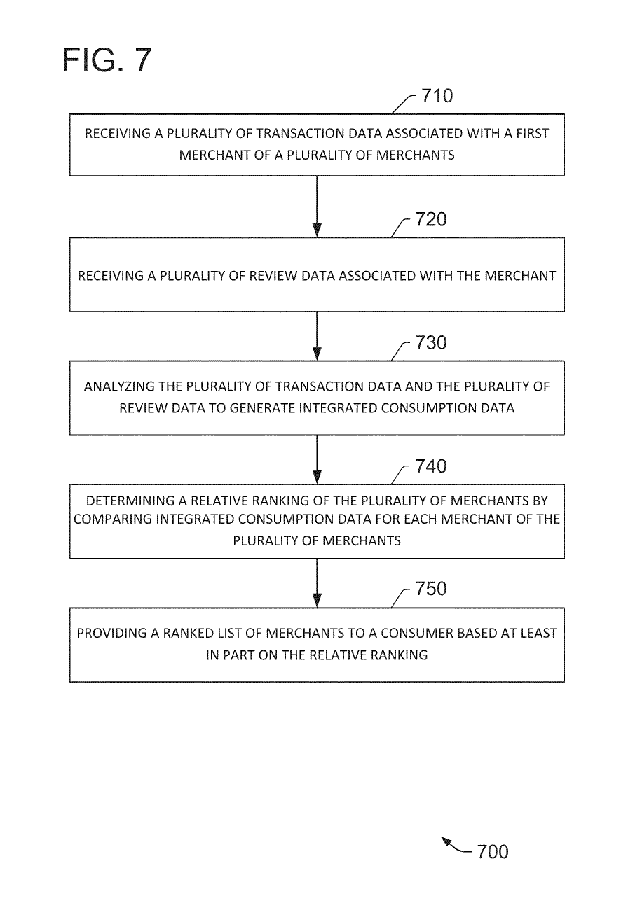

FIG. 7 is a simplified diagram of an example method 700 of recommending merchants 24 (shown in FIG. 1) to consumers 670 (shown in FIG. 6) using merchant evaluation computer system 112 (shown in FIGS. 2 and 3). Method 700 is accordingly carried out by merchant evaluation computer system 112. Merchant evaluation computer system 112 receives 710 a plurality of transaction data associated with a first merchant of a plurality of merchants. Receiving 710 represents merchant valuation computer system 112 receiving transaction data 610 (shown in FIG. 6) including a plurality of transaction records 612 (shown in FIG. 6) and associated with transaction merchant identifiers 614 (shown in FIG. 6) from a transaction party such as interchange network 28 (shown in FIG. 6).

Merchant evaluation computer system 112 also receives 720 a plurality of review data associated with the merchant. Receiving 720 represents receiving review data 620 (shown in FIG. 6) including review records 622 (shown in FIG. 6) and associated with review merchant identifiers 624 (shown in FIG. 6) from review resources 630 (shown in FIG. 6) that may include external review resources 632 (shown in FIG. 6) and internal review resources 634 (shown in FIG. 6).

Merchant evaluation computer system 112 additionally analyzes 730 the plurality of transaction data and the plurality of review data to generate integrated consumption data. Analyzing 730 represents processing transaction data 610 and review data 620 to determine integrated consumption data 650 (shown in FIG. 6). Analyzing 730 further represents determining scores 651, 652, 653, 654, and 660, merchant identifiers 655, merchant location identifier 656, merchant category identifier 657, merchant data 658, and weights 659 (all shown in FIG. 6).

Merchant evaluation computer system 112 also determines 740 a relative ranking of the plurality of merchants by comparing integrated consumption data for each merchant of the plurality of merchants. Determining 740 represents comparing integrated consumption data 650 for each merchant 24 to determine a ranking of merchants 24.

Merchant evaluation computer system 112 additionally provides 750 a ranked list of merchants to a consumer based at least in part on the relative ranking. Providing 750 represents sending ranked list 690 to consumer 670 (both shown in FIG. 6) based on the ranking determined 740 previously.

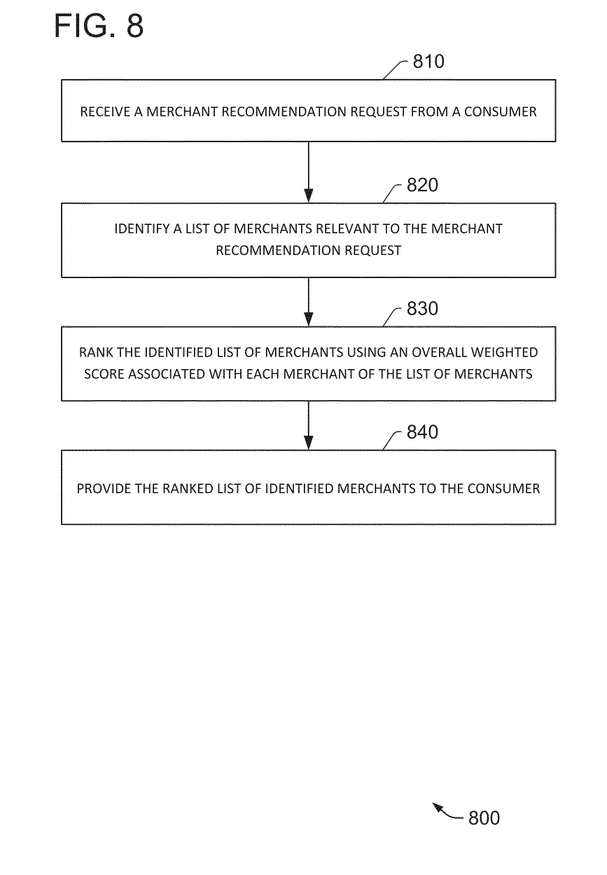

FIG. 8 is a simplified diagram of a further example method 800 of recommending merchants 24 (shown in FIG. 1) to consumers 670 (shown in FIG. 6) using merchant evaluation computer system 112 (shown in FIGS. 2 and 3.) Method 800 is implemented by merchant evaluation computer system 112. Merchant evaluation computer system receives 810 a merchant recommendation request from a consumer. Receiving 810 merchant recommendation request from a consumer represents merchant evaluation computer system 112 receiving merchant recommendation request 680 from consumer 670, wherein merchant recommendation request 680 includes a location of interest 682, at least one merchant category of interest 684, and a plurality of consumer preferences 686 (all shown in FIG. 6).

Merchant evaluation computer system 112 also identifies 820 a list of merchants relevant to the merchant recommendation request. Identifying 820 represents comparing integrated consumption data 650 (shown in FIG. 6) for each merchant 24 (shown in FIG. 1) to merchant recommendation request 680 to filter merchants 24 to those that are in location of interest 682 and of merchant category of interest 684 while also satisfying consumer preferences 686.

Merchant evaluation computer system 112 further ranks 830 the identified list of merchants using an overall weighted score associated with each merchant of the list of merchants. Ranking 830 represents ranking the list of merchants previously identified 820 by applying weights 659 to data in integrated consumption data 650 and ranking the resulting weighted overall scores 660 (all shown in FIG. 6).

Merchant evaluation computer system 112 additionally provides 840 the ranked list of identified merchants to consumer. Providing 840 represents sending ranked list 690 (shown in FIG. 6) to consumer 670 after ranking 830.

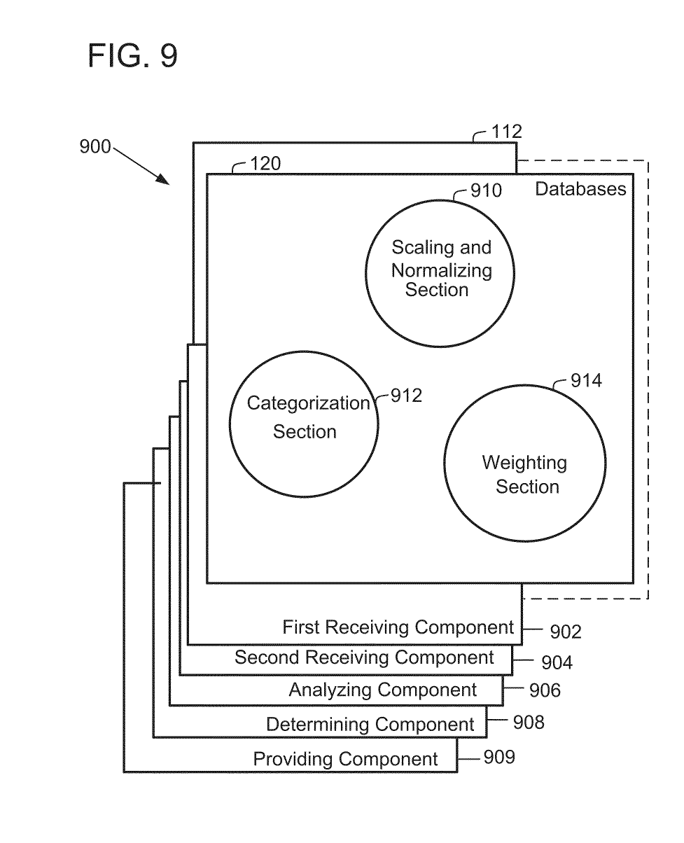

FIG. 9 is a diagram 900 of components of one or more example computing devices that may be used in the environment shown in FIG. 6. FIG. 9 further shows a configuration of databases including at least database 120 (shown in FIG. 1). Database 120 is coupled to several separate components within merchant evaluation computer system 112, which perform specific tasks.

Merchant evaluation computer system 112 includes a first receiving component 902 for receiving a plurality of transaction data associated with a first merchant of a plurality of merchants. Merchant evaluation computer system 112 also includes a second receiving component 904 for receiving a plurality of review data associated with the merchant. Merchant evaluation computer system 112 additionally includes an analyzing component 906 for analyzing the plurality of transaction data and the plurality of review data to generate integrated consumption data. Merchant evaluation computer system 112 also includes a determining component 908 for determining a relative ranking of the plurality of merchants by comparing integrated consumption data for each merchant of the plurality of merchants. Merchant evaluation computer system 112 further includes a providing component 909 for providing a ranked list of merchants to a consumer based at least in part on the relative ranking.

In an exemplary embodiment, database 120 is divided into a plurality of sections, including but not limited to, a scaling and normalizing section 910, a categorization section 912, and a weighting section 914. These sections within database 120 are interconnected to update and retrieve the information as required.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-implemented method for recommending a merchant to a consumer, the method implemented by a merchant evaluation computer system in communication with a memory, the method comprising:
receiving a plurality of transaction data associated with a first merchant of a plurality of merchants;
receiving a plurality of review data associated with the merchant;
analyzing, at the merchant evaluation computer system, the plurality of transaction data and the plurality of review data to generate integrated consumption data;
determining a relative ranking of the plurality of merchants by comparing integrated consumption data for each merchant of the plurality of merchants; and
providing a ranked list of merchants to a consumer based at least in part on the relative ranking.

2. The method of claim 1, wherein receiving the plurality of review data associated with the merchant further comprises:
scanning a plurality of external review resources for review data associated with the merchant; and
extracting review data from the plurality of external review resources.

3. The method of claim 1, wherein receiving the plurality of review data associated with the merchant further comprises:
requesting review data from a cardholder.

4. The method of claim 3, further comprising:
requesting review data from the cardholder based upon at least a portion of the received plurality of transaction data.

5. The method of claim 1, wherein analyzing the plurality of transaction data and the plurality of review data further comprises:
identifying a plurality of merchant values for the merchant, each of the plurality of merchant values associated with a review category;
assigning a weight to each of the plurality of review categories; and
weighting each of the merchant values based upon the assigned weights.

6. The method of claim 5, wherein determining the relative ranking of the merchant within the plurality of merchants further comprises:
ranking the merchant within the plurality of merchants based, at least in part, on the weighted merchant values.

7. The method of claim 1, further comprising:
identifying a merchant category associated with the merchant, wherein the merchant category is further associated with a plurality of merchants;
associating the merchant with the merchant category; and
ranking the merchant within the plurality of merchants of the merchant category.

8. The method of claim 1, further comprising:
receiving at least one cardholder preference; and
providing the ranked list of merchants to the cardholder based on the at least one cardholder preference.

9. A merchant evaluation computer system used to recommend a merchant to a consumer, the merchant evaluation computer system comprising:
a processor; and
a memory coupled to said processor, said processor configured to:
receive a plurality of transaction data associated with a first merchant of a plurality of merchants;
receive a plurality of review data associated with the merchant;
analyze the plurality of transaction data and the plurality of review data to generate integrated consumption data;
determine a relative ranking of the plurality of merchants by comparing integrated consumption data for each merchant of the plurality of merchants; and
provide a ranked list of merchants to a consumer based at least in part on the relative ranking.

10. A merchant evaluation computer system in accordance with claim 9 wherein the processor is further configured to:
scan a plurality of external review resources for review data associated with the merchant; and
extract review data from the plurality of external review resources.

11. A merchant evaluation computer system in accordance with claim 9 wherein the processor is further configured to:
request review data from a cardholder.

12. A merchant evaluation computer system in accordance with claim 11 wherein the processor is further configured to:
request review data from the cardholder based upon at least a portion of the received plurality of transaction data.

13. A merchant evaluation computer system in accordance with claim 9 wherein the processor is further configured to:
identify a plurality of merchant values for the merchant, each of the plurality of merchant values associated with a review category;
assign a weight to each of the plurality of review categories; and
weight each of the merchant values based upon the assigned weights.

14. A merchant evaluation computer system in accordance with claim 13 wherein the processor is further configured to:
rank the merchant within the plurality of merchants based, at least in part, on the weighted merchant values.

15. A merchant evaluation computer system in accordance with claim 9 wherein the processor is further configured to:
identify a merchant category associated with the merchant, wherein the merchant category is further associated with a plurality of merchants;
associate the merchant with the merchant category; and
rank the merchant within the plurality of merchants of the merchant category.

16. A merchant evaluation computer system in accordance with claim 9 wherein the processor is further configured to:
receive at least one cardholder preference; and
provide the ranked list of merchants to the cardholder based on the at least one cardholder preference.

17. Computer-readable storage media for recommending a merchant to a consumer, the computer-readable storage media having computer-executable instructions embodied thereon, wherein, when executed by at least one processor, the computer-executable instructions cause the processor to:
receive a plurality of transaction data associated with a first merchant of a plurality of merchants;
receive a plurality of review data associated with the merchant;
analyze the plurality of transaction data and the plurality of review data to generate integrated consumption data;
determine a relative ranking of the plurality of merchants by comparing integrated consumption data for each merchant of the plurality of merchants; and
provide a ranked list of merchants to a consumer based at least in part on the relative ranking.

18. The computer-readable storage media in accordance with claim 17, wherein the computer-executable instructions cause the processor to:
scan a plurality of external review resources for review data associated with the merchant; and
extract review data from the plurality of external review resources.

19. The computer-readable storage media in accordance with claim 17, wherein the computer-executable instructions cause the processor to:
request review data from the cardholder based upon at least a portion of the received plurality of transaction data.

20. The computer-readable storage media in accordance with claim 17, wherein the computer-executable instructions cause the processor to:
identify a plurality of merchant values for the merchant, each of the plurality of merchant values associated with a review category;
assign a weight to each of the plurality of review categories; and
weight each of the merchant values based upon the assigned weights.
